(19) United States
(12) Patent Application Publication
(10) Pub. No.: US 2006/0088096 A1
(43) Pub. Date: Apr. 27, 2006

(54) Video coding method and apparatus

(75) Inventors: Woo-jin Han, Suwon-si (KR); Kyo-hyuk Lee, Seoul (KR); Bae-keun Lee, Bucheon-si (KR); Jae-young Lee, Suwon-si (KR); Sang-chang Cha, Hwaseong-si (KR); Ho-jin Ha, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/254,763

(22) Filed: Oct. 21, 2005

Related U.S. Application Data
(60) Provisional application No. 60/620,330, filed on Oct. 21, 2004.

(30) Foreign Application Priority Data
Dec. 1, 2004 (KR) 10-2004-0099952

(51) Int. Cl. H04N 11/04; H04B 1/66; H04N 11/02; H04N 7/12

(52) U.S. Cl. 375/240.03; 375/240.19

(57) ABSTRACT

A method and apparatus are provided for improving compression efficiency or picture quality by selecting a wavelet transform technique suitable to input video/image scene characteristics in video/image compression. The video encoder includes a temporal transform module that removes temporal redundancy of an input frame and generates a residual frame, a selection module that selects an appropriate wavelet filter among a plurality of wavelet filters having different taps according to a spatial correlation of the residual frame, a wavelet transform module that generates wavelet coefficients by performing wavelet transform on the residual frame using the selected wavelet filter, and a quantization module that quantizes the wavelet coefficients.

### CROSS-REFERENCE TO RELATED APPLICATIONS

This application claims priority from Korean Patent Application No. 10-2004-0099952 filed on Dec. 1, 2004 in the Korean Intellectual Property Office, and U.S. Provisional Patent Application No. 60/620,330 filed on Oct. 21, 2004 in the United States Patent and Trademark Office, the disclosures of which are incorporated herein by reference in their entirety.

### BACKGROUND OF THE INVENTION

1. Field of the Invention

Apparatuses and methods consistent with the present invention relate to video/image compression, and more particularly, to improving compression efficiency or picture quality by selecting a wavelet transform technique suitable to input video/image scene characteristics in video/image compression.

2. Description of the Related Art

With the development of information communication technology, including the Internet, there have been increasing multimedia services containing various kinds of information such as text, video, audio and so on. Multimedia data requires a large capacity of storage media and a wide bandwidth for transmission since the amount of multimedia data is usually large. Accordingly, a compression coding method is required for transmitting multimedia data including text, video, and audio.

A basic principle of data compression lies in removing data redundancy. Data can be compressed by removing spatial redundancy in which the same color or object is repeated in an image, temporal redundancy in which there is little change between adjacent frames in a moving image or the same sound is repeated in audio, or mental visual redundancy taking into account human eyesight and limited perception of high frequency.

Most of video coding standards are based on motion compensation/estimation coding. The temporal redundancy is removed using temporal filtering based on motion compensation, and the spatial redundancy is removed using spatial transform.

A transmission medium is required to transmit multimedia generated after removing the data redundancy. Transmission performance is different depending on transmission media. Currently used transmission media have various transmission rates. For example, an ultrahigh-speed communication network can transmit data of several tens of megabits per second while a mobile communication network has a transmission rate of 384 kilobits per second.

To support transmission media having various speeds or to transmit multimedia at a rate suitable to a transmission environment, data coding methods having scalability may be suitable to a multimedia environment.

Scalability indicates a characteristic that enables a decoder or a pre-decoder to partially decode a single compressed bitstream according to conditions such as a bit rate, an error rate, and system resources. A decoder or a pre-decoder can reconstruct a multimedia sequence having different picture quality, resolutions, or frame rates using only a portion of a bitstream that has been coded according to a method having scalability.

In Moving Picture Experts Group-21 (MPEG-21) Part 13, scalable video coding is being standardized. A wavelet-based spatial transform method is considered as the strongest candidate for such standardization.

FIG. 1 schematically illustrates a process of decomposing an input image or frame into subbands by wavelet transformation. For example, two-level wavelet transformation is performed to decompose the input image or frame into one low frequency subband and three horizontal, vertical, and diagonal high frequency subbands. The high frequency subbands in the horizontal, vertical, and both horizontal and vertical directions are referred to as the LH, HL, and HH subbands, respectively. The low frequency subband that is low frequency in both the horizontal and vertical directions is referred to as the LL subband. The low frequency subband LL is further decomposed iteratively. A number within the parenthesis denotes the level of wavelet transform.

There are various kinds of wavelet filters used in the wavelet transform. In recent years, a Haar filter, a 5/3 filter, a 9/7 filter, and so on, have been widely used. The Haar filter utilizes a method in which two adjacent pixels are decomposed into a low-frequency pixel and a high-frequency pixel. According to the 5/3 filter, a low-frequency pixel is generated by referencing 5 adjacent pixels and a high-frequency pixel is generated by 3 adjacent pixels. Likewise, according to the 9/7 filter, a low-frequency pixel is generated by referencing 9 adjacent pixels and a high-frequency pixel is generated by 7 adjacent pixels. In this case, a wavelet filter that references relatively many adjacent pixels is considered as having a longer tap, while a wavelet filter that references relatively less adjacent pixels is considered as having a shorter tap. For example, the 9/7 filter has a relatively longer tap than the 5/3 filter or the Haar filter.

FIGS. 2A and 2B illustrate frequency response characteristics of a Haar filter, and FIGS. 3A and 3B illustrates frequency response characteristics of a 9/7 filter. In FIGS. 2A and 3A, the graphical representations indicate response characteristics of a low frequency filter (Lx). In FIGS. 2B and 2C, the graphical representations indicate response characteristics of a high frequency filter (Hx).

Referring to FIGS. 2A through 3B, frequency responses of the Haar filter tend to spread out in the frequency region while frequency responses of the 9/7 wavelet filter tend to exhibit such that high frequency components and low frequency components are definitely separated from each other. Therefore, a low frequency filtered image becomes more clearly visible at its edge components by use of the Haar filter and becomes smoother by use of the 9/7 wavelet filter.

In a video encoder, a wavelet filter receives a temporal residual frame (to be referred to simply as a residual frame hereinbelow) to perform a wavelet transform. The residual frame may have a high or a low spatial correlation according to image characteristic. An image having a sufficiently high spatial correlation exhibits excellent coding efficiency because a wavelet filter having a longer tap more efficiently captures the spatial correlation of the image than a wavelet filter having a shorter tap. Conversely, for spatially irrelevant images, using the longer tap wavelet filter may not be appropriate and may undesirably result in a ringing effect.

Accordingly, there is a need for a method for performing spatial transformation by selecting an appropriate one of a plurality of wavelet filters according to characteristics of input temporal residual frames, that is, an adaptive spatial transforming method and apparatus, commonly arising in video/image compression.

### SUMMARY OF THE INVENTION

The present invention provides a method of performing a spatial transform by selecting an appropriate filter among a plurality of wavelet filters according to temporal residual frame characteristics in spatial transformation during video compression. That is to say, the present invention provides an adaptive spatial transformation method and apparatus.

The present invention also provides a method of applying the adaptive spatial transformation method to each partition divided within a frame.

According to an aspect of the present invention, there is provided a video encoder including a temporal transform module that removes temporal redundancy of an input frame and generates a residual frame, a selection module that selects an appropriate wavelet filter among a plurality of wavelet filters having different taps according to a spatial correlation of the residual frame, a wavelet transform module that performs a waveform transform on the residual frame using the selected wavelet filter and generates wavelet coefficients, and a quantization module that quantizes the wavelet coefficients.

According to another aspect of the present invention, there is provided an image encoder including a selection module that selects an appropriate wavelet filter among a plurality of wavelet filters having different taps according to a spatial correlation of input images, a wavelet transform module that performs a wavelet transform using the selected wavelet filter to generate wavelet coefficients, and a quantization module that quantizes the wavelet coefficient.

According to still another aspect of the present invention, there is provided a video encoder including a temporal transform module that removes temporal redundancy of an input frame and generates a residual frame, a wavelet transform module that performs wavelet transforms on the residual frame using a plurality of wavelet filters and generates plural sets of wavelet coefficients, a quantization module that quantizes the plural sets of wavelet coefficients and generates plural sets of quantized coefficients, and a selection module that reconstructs a plurality of residual frames from the plural sets of quantized coefficients, compares the quality differences of the plurality of residual frames with each other and selects a wavelet filter for a frame having a better quality.

According to a further aspect of the present invention, there is provided a video encoder comprising a temporal transform module that removes temporal redundancy of an input frame and generates a residual frame, a partition module that divides the residual frame into partitions having a predetermined size, a selection module that selects an appropriate wavelet filter among a plurality of wavelet filters having different taps according to a spatial correlation of the divided partitions, a wavelet transform module that performs a waveform transform on the residual frame using the selected wavelet filter and generates wavelet coefficients, and a quantization module that quantizes the wavelet coefficients.

According to yet another aspect of the present invention, there is provided a video encoder including a temporal transform module that removes temporal redundancy of an input frame and generates a residual frame, a partition module that divides the residual frame into partitions having a predetermined size, a wavelet transform module that performs a wavelet transform on the partitions using a plurality of wavelet filters and generates plural sets of wavelet coefficients, a quantization module that quantizes the plural sets of wavelet coefficients and generates plural sets of quantized coefficients, and a selection module that reconstructs a plurality of residual partitions from the plural sets of quantized coefficients, compares quality differences of the plurality of residual partitions with each other and selects a wavelet filter for a frame having a better quality.

According to yet a further aspect of the present invention, there is provided a video decoder including an inverse quantization module that inversely quantizes texture data contained in an input bitstream, an inverse wavelet module that performs an inverse wavelet transform on the texture data using an inverse wavelet filter among a plurality of inverse wavelet filters, the inverse wavelet filter corresponding to mode information included in the bitstream, and an inverse temporal transform module that performs an inverse temporal transform and reconstructs a video sequence using the inverse wavelet transform result and motion information included in the bitstream.

According to still yet another aspect of the present invention, there is provided a video decoder including an inverse quantization module that inversely quantizes texture data contained in an input bitstream, an inverse wavelet module that performs an inverse wavelet transform on the texture data for each partition using an inverse wavelet filter among a plurality of inverse wavelet filters, the inverse wavelet filter corresponding to mode information included in the bitstream, a partition combination module that combines the wavelet-transformed partitions and reconstructs a residual image, and an inverse temporal transform module that reconstructs a video sequence using the residual image and the motion information included in the bitstream.

### BRIEF DESCRIPTION OF THE DRAWINGS

The above and other aspects of the present invention will become more apparent by describing in detail exemplary embodiments thereof with reference to the attached drawings in which:

FIG. 1 is a schematic diagram illustrating wavelet transformation;

FIGS. 2A and 2B illustrate frequency response characteristics of a Haar filter;

FIGS. 3A and 3B illustrate frequency response characteristics of a 9/7 filter;

FIG. 4 is a block diagram of a scalable video encoder according to an exemplary embodiment of the present invention;

FIG. 5 illustrates a decomposition process shown in FIG. 1;

FIG. 6 is a schematic diagram illustrating a process of decomposing pixels into low frequency pixels and high frequency pixels using a Haar filter;

FIG. 7 illustrates a wavelet filtering process in which a variety of taps are provided;

FIG. 8 is a block diagram of a video encoder having a still image as an input and encoding the same according to an exemplary embodiment the present invention;

FIG. 9 is a block diagram of a scalable video encoder according to another exemplary embodiment of the present invention;

FIG. 10 is a detailed block diagram of a selection module;

FIG. 11 is a diagram schematically illustrating the overall structure of a bitstream;

FIG. 12 is a detailed diagram of a GOP field;

FIG. 13 is a detailed diagram of an MV field;

FIG. 14 is a detailed diagram of “the other T” field in an exemplary embodiment illustrating modes determined by frame;

FIG. 15 is a detailed diagram of “the other T” field in an exemplary embodiment illustrating modes determined by color component;

FIG. 16 is a block diagram of a scalable video encoder according to another exemplary embodiment of the present invention;

FIG. 17 illustrates an example of decomposing an input residual frame into 4×4 blocks;

FIG. 18 is a detailed diagram of “the other T” field in an exemplary embodiment illustrating modes determined by partition;

FIG. 19 is a block diagram of a scalable video encoder according to still another exemplary embodiment of the present invention;

FIG. 20 is a schematic diagram of a video decoder according to an exemplary embodiment of the present invention;

FIG. 21 is a schematic diagram of a video decoder according to an exemplary embodiment of the present invention;

FIG. 22 is a graph showing PSNR difference depending on Y-U-V component when mobile sequences are encoded with adaptive spatial transformation and without adaptive spatial transformation; and

FIG. 23 is a block diagram of a system for performing an encoding or decoding method according to an exemplary embodiment of the present invention.

### DETAILED DESCRIPTION OF EXMPLARY EMBODIMENTS OF THE INVENTION

The present invention will now be described more fully with reference to the accompanying drawings, in which exemplary embodiments of this invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

Throughout the specification, the term “video” indicates a moving picture, and the term “image” indicates a still picture.

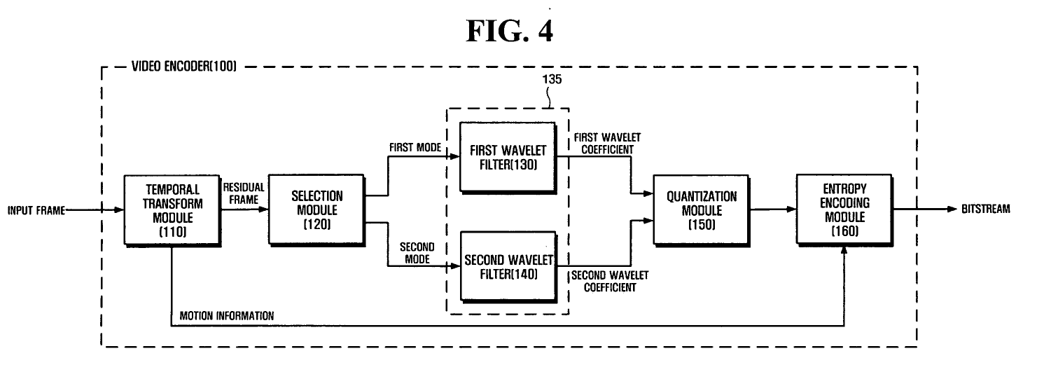

FIG. 4 is a block diagram of a video encoder 100 according to an exemplary embodiment of the present invention. The video encoder 100 includes a temporal transform module 1 10, a selection module 120, a wavelet transform module 135, a quantization module 150, and an entropy encoding module 160. The exemplary embodiment shown in FIG. 4 illustrates a process of selecting an appropriate one among a plurality of wavelet filters, that is, mode selection is performed before spatial transform is performed by a wavelet filter.

The temporal transform module 110 obtains a motion vector based on motion estimation, constructs temporal prediction frames using the obtained motion vector and a reference frame, and obtains a difference between a current frame and the motion-compensated frame, thereby reducing temporal redundancy. The motion estimation may be performed using fixed size block matching or hierarchical variable size block matching (HVSBM).

For the temporal filtering, an IBP technique using intra-coded “I” picture, predictive “P” picture, and bidirectional “B” picture, which is used in the conventional MPEG-series encoders or hierarchical temporal filtering such as Motion Compensated Temporal Filtering (MCTF) or Unconstrained Motion Compensated Temporal Filtering (UMCTF) may be used.

The selection module 120 selects an appropriate wavelet filter among a plurality of wavelet filters according to image characteristics of input residual frames. That is to say, the selection module 120 determines whether input residual frames have a high spatial correlation with each other, selects a relatively longer tap wavelet filter for images having a high spatial correlation, and selects a relatively shorter tap wavelet filter for images having a low spatial correlation. Here, the first case in which the relatively shorter tap wavelet filter is selected is defined as a “first mode”, and the latter case in which the relatively longer tap wavelet filter is selected is defined as a “second mode”.

The selection module 120 selects one among a plurality of wavelet filters 130 and 140 according to a selected mode, and provides the input residual frame to the wavelet transform module 135 according to the selected mode. In the exemplary embodiment as shown in FIG. 4, in which one of two wavelet filters, that is, a first wavelet filter, is selected by way of example, the first wavelet filter has a shorter tap than the other wavelet filter, that is, a second wavelet filter.

The present exemplary embodiment aims to propose an exemplary quantitative criterion of determining a spatial correlation between pixels. Images having a high spatial correlation have pixels of a specific brightness densely distributed while images having a low spatial correlation have pixels of multiple levels of brightness evenly distributed, resulting in similarity in random noise. It is presumable that histograms of images having random noises (the x-axis indicates brightness and the y-axis indicates occurrence) are well compliant with the Gaussian distribution. On the other hand, it is presumable that the images having a high spatial correlation are not well compliant with the Gaussian distribution because the images having a high spatial correlation has pixels of a specific brightness densely distributed.

For example, when preparing a histogram for an input residual frame, as a criterion for mode selection, it is determined whether a difference between a current distribution and the Gaussian distribution is greater than a predetermined critical value. If the difference is greater than the predetermined critical value, the input residual frame is an image having a high spatial correlation, so that a second mode is selected. If the difference is not greater than the predetermined critical value, the input residual frame is an image having a low spatial correlation, so that a first mode is selected.

More specifically, a difference between the current distribution and the Gaussian distribution may be based on a sum of frequency differences by various variables. First, the mean (m) and standard deviation (σ) of the current distribution are obtained and a Gaussian distribution having the mean and standard deviation is then obtained. Then, as expressed by Equation 1, a sum of differences between each of frequencies (fᵢ) of various variables exhibited in the current distribution and each of frequencies ((f_{g})ᵢ) of corresponding variables assumed in the Gaussian distribution, is divided by the total frequencies, which is for the purpose of normalization. That is to say, in order to perform normalization, the denominator is divided by the total number of the current distribution. Then, it is determined whether the result value is greater than the predetermined critical value (c).

$$\frac{{\sum }_{i} \vert {f}_{i} - {( {f}_{g} )}_{i} \vert}{{\sum }_{i} {f}_{i}} > c \qquad [ Equation 1 ]$$

As described above, the determination criterion is applied to the residual frame. In addition, the determination criterion may directly be applied to an original video frame that is not yet subjected to a temporal transform.

The wavelet transform module 135 performs a wavelet transform on the residual frame using a wavelet filter selected from a plurality of wavelet filters 130 and 140 and generates wavelet coefficients. This wavelet transformation process is a process of decomposing a frame into low frequency subbands and high frequency subbands and obtaining wavelet coefficients of the respective pixels.

Specifically, the first wavelet filter 130 is a wavelet filter having a relatively shorter tap and performing a wavelet transform on the input residual frame when the selection module 120 selects the first mode. The second wavelet filter 140 is a wavelet filter having a relatively longer tap and performing a wavelet transform on an input residual frame when the selection module 120 selects the second mode. For example, the first wavelet filter may be a Haar filter, and the second wavelet filter may be a 9/7 filter.

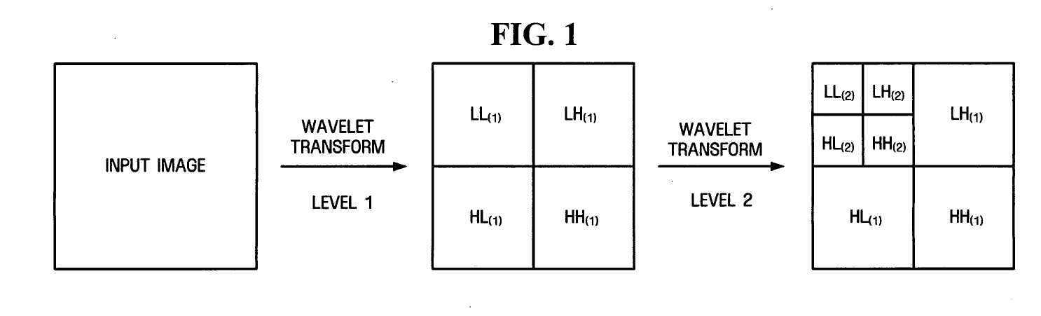

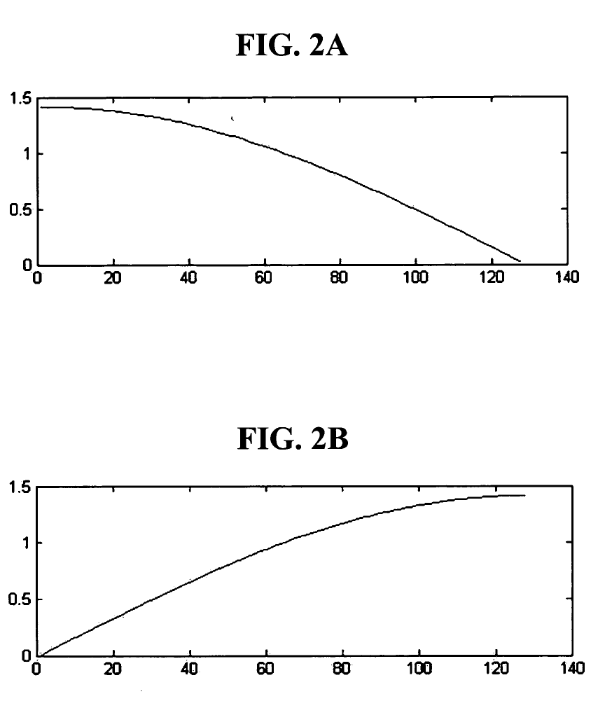

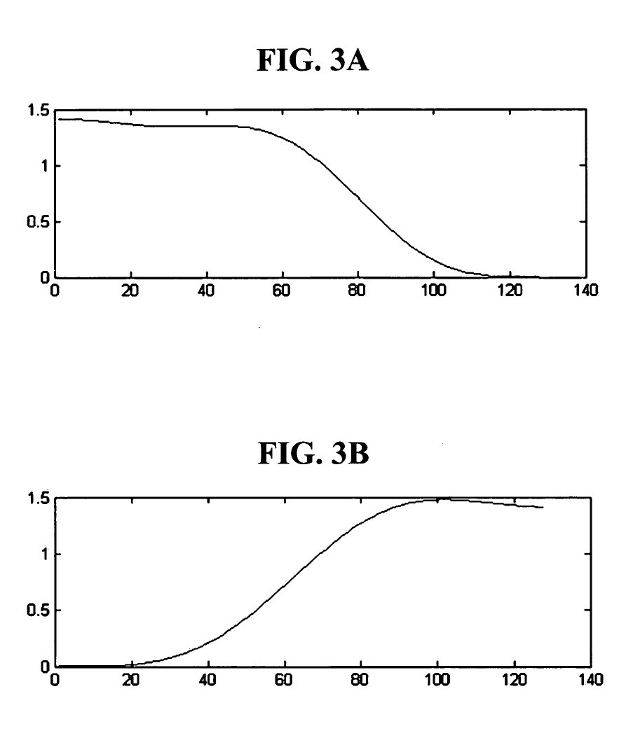

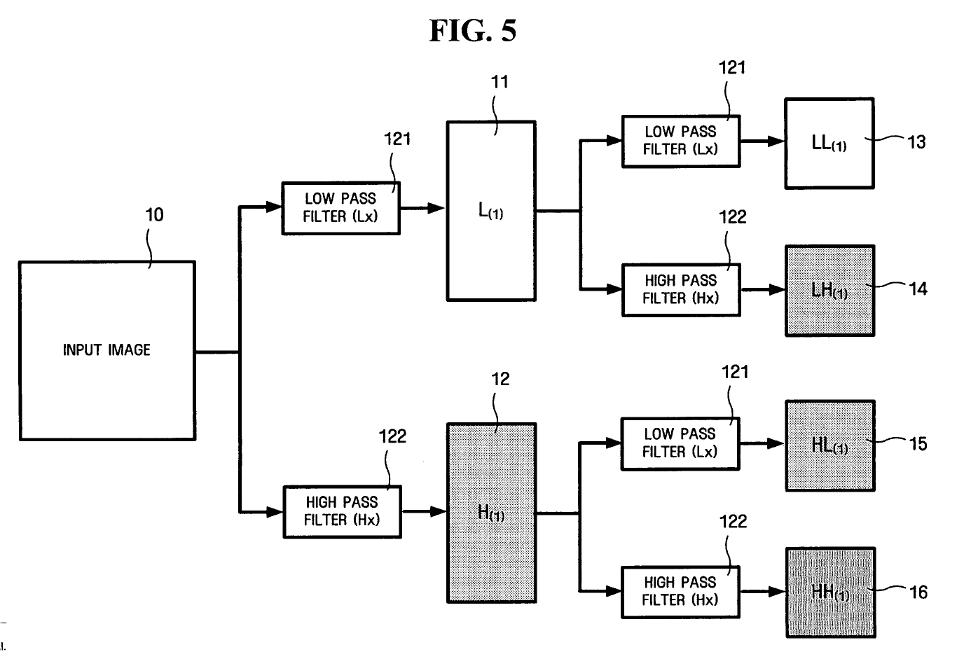

FIG. 5 illustrates a decomposition process shown in FIG. 1. Each of the wavelet filters 130 and 140 includes a low pass filter 121 and a high pass filter 122. According to the kinds of the low pass filter 121 and/or the high pass filter 122 used, the wavelet filters 130 and 140 can be classified as a Haar filter, 5/3 filter, 9/7 filter, or the like. Coding performance and picture quality may vary according to the wavelet filter used.

If the input image 10 passes through the low pass filter 121, a low frequency image (L₍₁₎) 11 whose horizontal (or vertical) width is reduced to half is produced. If the input image 10 passes through the high pass filter 122, a high frequency image (H₍₁₎) 12 whose horizontal (or vertical) width is reduced to half is produced.

If the half-reduced low frequency image 11 and the high frequency image 12 are again passed through the low pass filter 121 and the high pass filter 122, four subband images, LL₍₁₎(13), LH₍₁₎(14), HL₍₁₎(15), HH₍₁₎(16) are produced.

If the subbands are further to be decomposed in the level 2, the low frequency image LL₍₁₎ 13 among the subband images is further decomposed into four subband images, that is, LL₍₂₎, LH₍₂₎, HL₍₂₎, and HH₍₂₎, as shown in FIG. 1.

As described above, the subband generating process using a two-dimensional wavelet transform is commonly employed in various wavelet filters. However, the expression used for decomposing a frame into a high frequency frame and a low frequency frame is different depending on wavelet filter used.

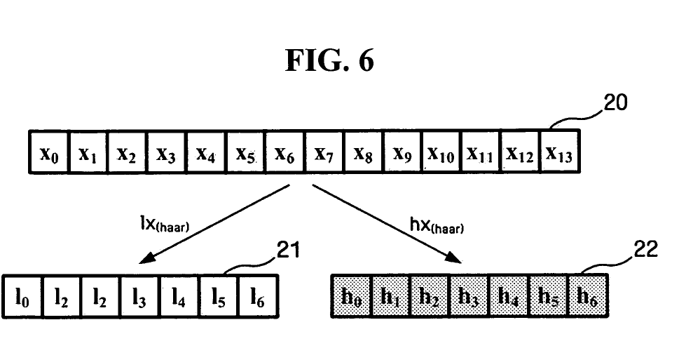

FIG. 6 is a schematic diagram illustrating a process of decomposing 2n pixels 20 into n low frequency pixels 21 and n high frequency pixels 22 using a Haar filter.

The Haar filter generates a low frequency pixel 10 and a high frequency pixel h0 from two adjacent pixels, e.g., x₀ and x₁. Filtering using the Haar filter is represented by Equation 2:

$${l}_{i} = \frac{1}{2} ( {x}_{2} + {x}_{2 i + 1} ) \\ {h}_{i} = \frac{1}{2} ( {x}_{2 i} + {x}_{2 i + 1} ) \qquad [ Equation 2 ]$$

where xᵢ is an i-th pixel, lᵢ is an i-th low frequency pixel, hᵢ is an i-th high frequency pixel, and an index i is an integer greater than or equal to 0.

A process of reconstructing two original pixels from the two pixels wavelet decomposed using the Haar filter, that is, an inverse wavelet transform, is represented by Equation 3:
x₂ᵢ=lᵢ+hᵢ
x₂ᵢ₊ₗ=lᵢ−hᵢ [Equation 3]
where lᵢ and hᵢ are a low frequency pixel and a high frequency pixel of the same position at the lower subbands, x₂ᵢ is an even-numbered pixel to be reconstructed, and x₂ᵢ₊₁ is an odd-numbered pixel to be reconstructed. Here, it is notable that the first pixel is an even-numbered pixel because reference symbol i starts from 0.

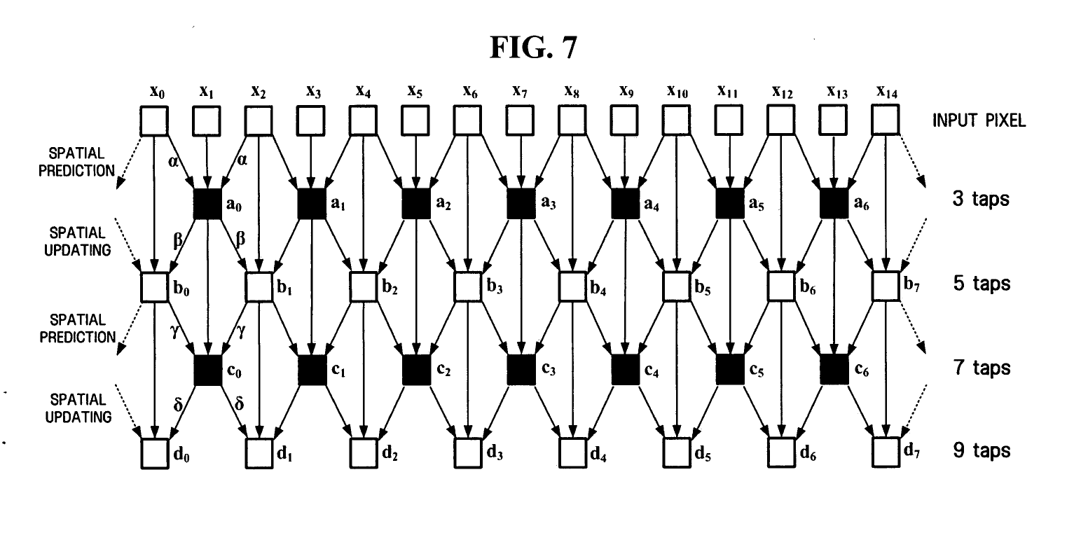

Meanwhile, an filtering expression using a wavelet filter having a tap longer than the Haar filter, such as the 5/3 filter or the 9/7 filter, can be created through continuous spatial prediction and spatial update processes, as shown in FIG. 7.

First, odd-numbered pixels among input pixels x0 through x₁₃ are subjected to spatial prediction to produce high frequency pixels a₀ through a₆. In this case, information on the adjacent pixels (e.g., influence ratio coefficient α=−½) is taken into consideration, which is represented by the following Equation 4.

$${a}_{i} = {x}_{2 i + 1} - \frac{1}{2} ( {x}_{2 i} + {x}_{2 i + 2} ) \qquad [ Equation 4 ]$$

Then, even-numbered pixels are subjected to spatial updating using adjacent pixels (e.g., influence ratio coefficient β=¼) among the high frequency pixels a₀ through a₆, to produce low frequency pixels b₀ through b₇. In this case, the spatial updating is represented by the following Equation 5.

$${b}_{i} = {x}_{2 i} + \frac{1}{4} ( {a}_{i - 1} + {a}_{i} ) \qquad [ Equation 5 ]$$

Referring to FIG. 7, since the high frequency pixels a₀ through a₆ reflect information on 3 adjacent pixels, they have 3 taps. Since the low frequency pixels b₀ through b₇ reflect information on 5 adjacent pixels, they have 5 taps. In such a manner, a wavelet filter that produces low frequency pixels using 5 adjacent pixels, including itself, and high frequency pixels using 3 adjacent pixels, including itself, is called a 5/3 filter.

If an even longer tap wavelet filtering is intended to perform, spatial prediction and spatial updating may be repeatedly performed. Ultimately, low frequency pixels d₀ through d₇ are produced using 9 adjacent pixels and high frequency pixels c₀ through c₇ are produced 7 adjacent pixels, and a wavelet filter used in this process is called a 9/7 filter. In the second spatial prediction and temporal prediction, different influence ratio coefficients (γ, δ) from the first ones (α, β) may be used.

As described above, a longer tap wavelet filter can be generated by repeating spatial prediction and spatial updating processes. However, in practice, the sequential processes are not necessarily performed but filtering result values can be directly produced by an equation.

Table 1 illustrates filter coefficients of a 5/3 filter, and Table 2 illustrates filter coefficients of a 9/7 filter.

TABLE 1

| K | Low-pass filter (hₖ) | High-pass filter (gₖ) |
|---|---|---|
| 0 | 6/8 | 1 |
| ±1 | 2/8 | −1/2 |
| ±2 | −1/8 | |

TABLE 2

| K | Low-pass filter (hₖ) | High-pass filter (gₖ) |
|---|---|---|
| 0 | 0.6029490182363579 | 1.115087052456994 |
| ±1 | 0.2668641184428723 | −0.5912717631142470 |
| ±2 | −0.07822326652898785 | −0.05754352622849957 |
| ±3 | −0.01686411844287495 | 0.09127176311424948 |
| ±4 | 0.02674875741080976 | |

Using the 5/3 filter coefficients shown in Table 1 allows low frequency frames (bᵢ) and high frequency frames (aᵢ) to be expressed by a combination, that is, Equation 6.

$${b}_{i} = - \frac{1}{8} {x}_{2 i - 2} + \frac{2}{8} {x}_{2 i - 1} + \frac{6}{8} {x}_{2 i} + \frac{2}{8} {x}_{2 i + 1} - \frac{1}{8} {x}_{2 i + 2} \\ {a}_{i} = - \frac{1}{2} {x}_{2 i} + {x}_{2 i + 1} - \frac{1}{2} {x}_{2 i + 2} \qquad [ Equation 6 ]$$

Likewise, using the 9/7 filter coefficients shown in Table 2 low frequency frames (dᵢ) and high frequency frames (cᵢ) to be expressed by linear combinations of 9 pixel values and 7 pixel values, respectively.

As described above, an encoder end generates low frequency pixels and high frequency pixels using linear combinations of a plurality of pixel values, and the generated low frequency pixels and high frequency pixels constitute low frequency frames and high frequency frames. On the other hand, a decoder end performs an inverse wavelet transform and reconstructs original pixels using input low frequency pixels and high frequency pixels. This is only a solution process of a linear equation having a predetermined number (3, 5, 7, 9, etc.) of variables and a detailed computation process will not be explained.

Referring back to FIG. 4, the quantization module 150 quantizes wavelet coefficients (first wavelet coefficients or second wavelet coefficients) generated from the wavelet transform module 135. Quantization means a process of dividing the DCT coefficients represented by arbitrary real numbered values into predetermined intervals to represent the same as discrete values and matching the discrete values with indices from a predetermined quantization table.

The entropy encoding module 160 loselessly codes the received quantized coefficients, and motion information provided from the temporal transform module 110 such as motion vectors, or reference frame number used in temporal transformation, and generates output bitstreams. Examples of the losslessly coding method include Huffinan coding, arithmetic coding, variable length coding, and so on.

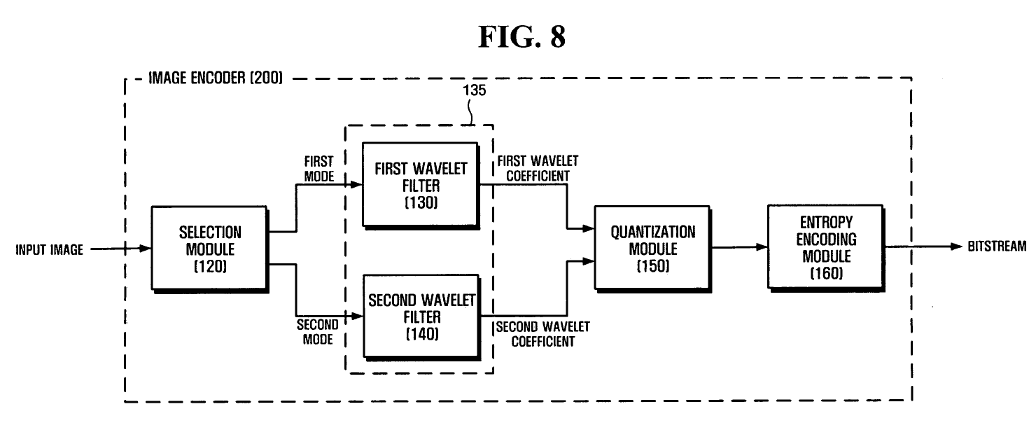

While it has been described in FIG. 4 that the first input is a video frame, the present invention is not limited thereto. A still image can also be coded according to the invention, which is shown in FIG. 8 illustrating an exemplary video encoder 200 having a still image as an input and encoding the same according to an exemplary embodiment the present invention.

The video encoder 100 shown in shown in FIG. 4 and the video encoder 200 shown in FIG. 8 are substantially the same except that the temporal transform module 110 is not provided in the video encoder 200. That is to say, the original input image is directly input to a selection module 120. For the input image, the selection module 120 selects a mode in the same manner as described above.

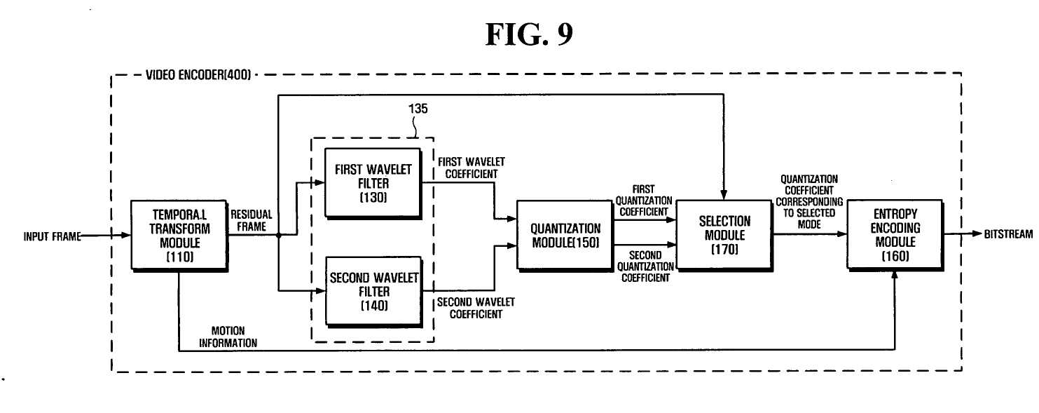

FIG. 9 is a block diagram of a video encoder 400 according to another exemplary embodiment of the present invention. Unlike in the exemplary embodiment shown in FIG. 4, in the exemplary embodiment of FIG. 9, a selection module 170 is provided after performing quantization. A video encoder 400 may include a temporal transform module 110, a wavelet transform module 135, a quantization module 150, a selection module 170, and an entropy encoding module 160. The following description will be made with reference to differences from the exemplary embodiment shown in FIG. 4.

A residual frame generated from the temporal transform module 110 is input to a first wavelet filter 130 and a second wavelet filter 140.

The wavelet transform module 135 performs a wavelet transform on the residual frame using a plurality of wavelet filters 130, 140. As a result, plural sets of wavelet coefficients are generated. That is to say, assuming that a collection of wavelet coefficients produced by performing a wavelet transform on one residual frame is called a set of wavelet coefficients, if one residual frame is subjected to a wavelet transform using each of a plurality of wavelet filters, plural sets of wavelet coefficients are generated. Referring to FIG. 9, two sets of wavelet coefficients exist. Specifically, a set of wavelet coefficients generated by a first wavelet filter 130 having a relatively shorter tap are called first wavelet coefficients and a set of wavelet coefficients generated by a second wavelet filter 140 having a relatively longer tap are called second wavelet coefficients.

The quantization module 150 quantizes the plural sets of wavelet coefficients and generates plural sets of quantized coefficients. That is to say, the quantization module 150 quantizes the first wavelet coefficients to generate first quantized coefficients and quantizes the second wavelet coefficients to generate second quantized coefficients.

The selection module 170 reconstructs a plurality of residual frames from the plural sets of quantized coefficients, compares quality differences of the plurality of residual frames with each other and selects a wavelet filter for a frame having better quality. For example, a first residual frame and a second residual frame are reconstructed from the first quantized coefficients and the second quantized coefficients, respectively, and a quality difference between the first residual frame and the second residual frame is compared on the basis of a residual frame supplied from the temporal transform module 110. A wavelet filter for a frame having a better quality is selected, that is, a first wavelet filter is selected in a case where the quality of the first residual frame is better, or a second wavelet filter is selected in a case where the quality of a second residual frame is better. A selection mode based on the selected quantized coefficient is supplied to the entropy encoding module 160.

The entropy encoding module 160 receives the quantized coefficients supplied from the selection module 170, that is, first quantized coefficients in a case of a first mode, or second quantized coefficients in a case of a second mode. Then, the entropy encoding module 160 losslessly codes the received quantized coefficients, and motion information provided from the temporal transform module 110 such as motion vectors, or reference frame number used in temporal transformation, and generates output bitstreams. Examples of the losslessly coding method include Huffinan coding, arithmetic coding, variable length coding, and so on.

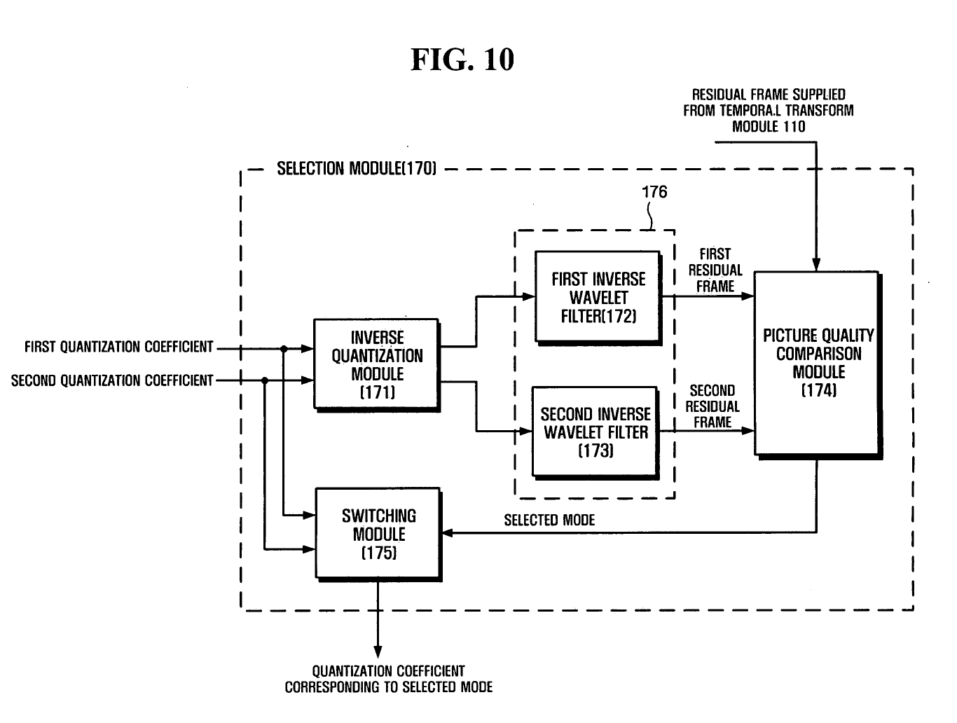

Referring to FIG. 10, the selection module 170 includes an inverse quantization module 171, an inverse wavelet transform module 176, a picture quality comparison module 174, and a switching module 175.

The inverse quantization module 171 performs inverse quantization on the plural sets of quantized coefficients supplied from the quantization module 150, that is, the first quantized coefficients and the second quantized coefficients. The inverse quantization process is a process of reconstructing values matched to indices generated during quantization using the quantization table.

The inverse wavelet transform module 176 includes a plurality of inverse wavelet filters 172 and 173, and transforms the inversely quantized results using the corresponding inverse wavelet filters to reconstruct a plurality of residual frames. Here, the first inverse wavelet filter 172 is an inverse transform filter corresponding to the first wavelet filter 130, and the second wavelet filter 173 is an inverse transform filter corresponding to the second wavelet filter 140.

The first inverse wavelet filter 172 performs a wavelet transform on inversely quantized values of the first quantized coefficients in a reverse order with respect to that by the first wavelet filter 130, thereby generating first residual frames. The second inverse wavelet filter 173 performs a wavelet transform on inversely quantized values of the second quantized coefficients in a reverse order with respect to that by the second wavelet filter 140, thereby generating second residual frames.

The picture quality comparison module 174 compares qualities of the reconstructed plurality of residual frames with the quality of the residual frame supplied from the temporal transform module 110, and selects a wavelet filter for a frame having better quality. That is, picture qualities of a first residual frame and a second residual frame are compared with each other based on the residual frame supplied from the temporal transform module 110, and one of them having a better quality is selected. For picture quality comparison, a sum of quality differences between the first residual frame and original residual frame is compared with a sum of quality differences between each of the second residual frames and original reference frame, and it is determined that the residual frame corresponding to a smaller sum has a better quality. As described above, one way of performing picture quality comparison is to simply compute quality differences between each of the respective residual frames. An alternative way of performing picture quality comparison is to compute Peak Signal-to-Noise Ratio (PSNR) values of the reconstructed plurality of residual frames, on the basis of the original residual frame. The PSNR method may also be implemented without departing from the basic principle of the present invention in which the PSNR values are computed by a sum of differences between each of images.

Alternatively, the above-stated quality comparison methods may also be performed such that the residual frames are subjected to inversely temporal transform and reconstructed frames are compared with each other. Since temporal transform is commonly performed in both comparison methods, quality comparison can be more effectively performed on the residual frames than on the reconstructed frames.

The switching module 175 supplies the quantized coefficient selected from the first quantized coefficients and the second quantized coefficients according to the mode selected by the picture quality comparison module 174 to the entropy encoding module 160.

The exemplary embodiment shown in FIG. 9 can be applied to an image encoder as well as the video encoder. In a case where the invention is applied to an image encoder, the temporal transform module 110 is not provided and there is no motion information. The image encoder is different from the video encoder in that an input image is directly input to the first wavelet filter 130, the second wavelet filter 140, and the selection module 170.

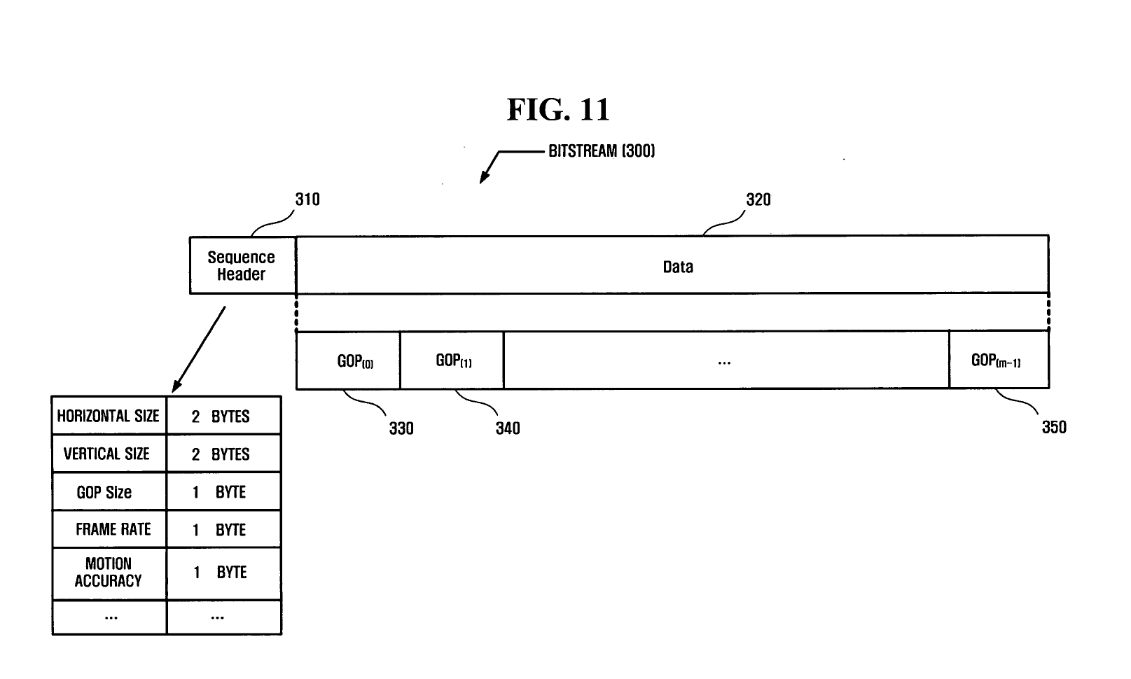

FIGS. 11 through 14 illustrate a structure of a bitstream 300 according to the present invention. Specifically, FIG. 11 is a diagram schematically illustrating the overall structure of a bitstream 300.

The bitstream 300 consists of a sequence header field 310 and a data field 320 containing at least one GOP field 330 through 350.

The sequence header field 310 specifies image properties such as frame width (2 bytes) and height (2 bytes), a GOP size (1 byte), a frame rate (1 byte), and motion accuracy (1 byte).

The data field 320 specifies image data representing images and other information needed to reconstruct the images, i.e., motion vector, reference frame number, and so on.

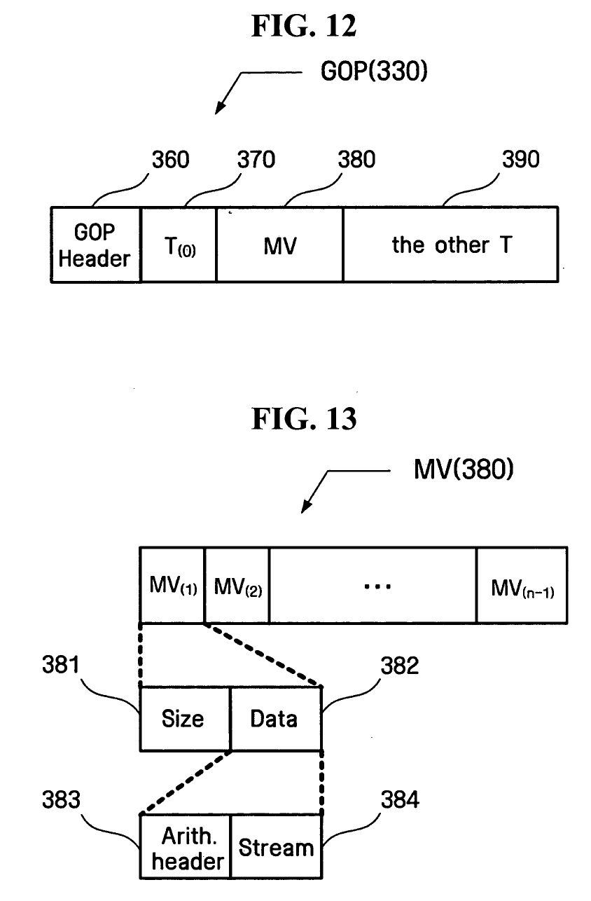

FIG. 12 illustrates the detailed structure of each GOP field 310. The GOP field 310 consists of a GOP header field 360, a T₍₀₎ field 370 in which information on the first frame (an I frame) in view of the temporal filtering order is recorded, a MV field 380 in which sets of motion vectors is recorded, and “the other T” field 390 in which information on frames (H frames) other than the first frame (an I frame) is recoded.

Unlike in the sequence header field 310 in which the overall image features are recorded, limited image features in a pertinent GOP are recorded in the GOP header field 360. Specifically, a temporal filtering order may be recorded in the GOP header field 360, or a temporal level in the exemplary embodiment shown in FIG. 9, which is, however, on the assumption that the information recorded in the GOP header field 360 is different from that recoded in the sequence header field 310. In a case where the same temporal filtering order or temporal level is used for the overall image, the corresponding information is advantageously recorded in the sequence header field 310.

FIG. 13 is a detailed diagram of the MV field 380.

The MV field 380 includes as many fields as the number of motion vectors, each motion vector field is further divided into a size field 381 indicating a size of a motion vector, and a data field 382 in which actual data of the motion vector is recorded. In addition, the data field 382 includes a header 383 and a stream field 384. The header 383 has information based on an arithmetic encoding method by way of example. Otherwise, the header 383 may have information on other coding methods, e.g., Huffmann coding. The stream field 384 has binary information on an actual motion vector recorded therein.

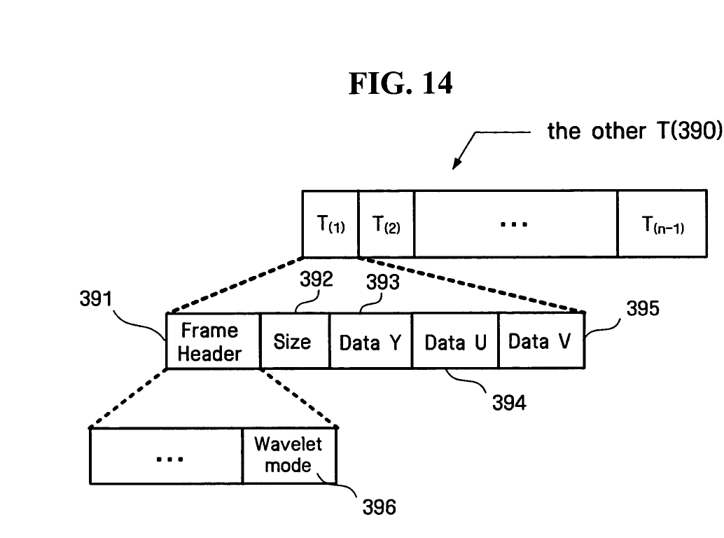

FIG. 14 is a detailed diagram of “the other T” field 390, in which information on H frames of a number equal to the number of frames minus one.

The field 390 containing the information on each of the H frames, is further divided into a frame header field 391, a data Y field 393 in which brightness components of the H frame are recorded, a Data U field 394 in which blue chrominance components are recorded, a Data V field 395 in which red chrominance components are recorded, and a size field 392 indicating a size of each of the Data Y field 393, the Data U field 394, and the Data V field 395.

Unlike in the sequence header field 310 or the GOP header field 360, limited image features in a pertinent frame are recorded in the frame header field 391. The frame header field 391 includes a wavelet mode field 396 in which mode information selected from the selection module 120 or 170 is recorded, so that the kind of a wavelet filter by frame, as selected at the video encoder using the field 396, can be informed of to the video decoder.

In the exemplary embodiments shown in FIGS. 4 through 14, it has been described by way of example that, for each frame input to a video encoder, one wavelet filter suitable for the input frame among a plurality of wavelet filters, i.e., a mode, is selected, and encoding is performed using the selected filter. That is, when another method such as embedded zero-tree wavelet (EZW) or set partitioning in hierarchical trees (SPHIT) is employed, the information corresponding to the method employed will be recorded in the header field 396.

In another alternatively, a frame may further be decomposed by color component, for example, by Y, U, and V components, or R, G, and B components, for mode selection. In this case, a wavelet filter for each of Y, U, and V components within an input frame is selected. A detailed selection process thereof is substantially the same as in the case of the selection process per a frame and an explanation thereof will not be given.

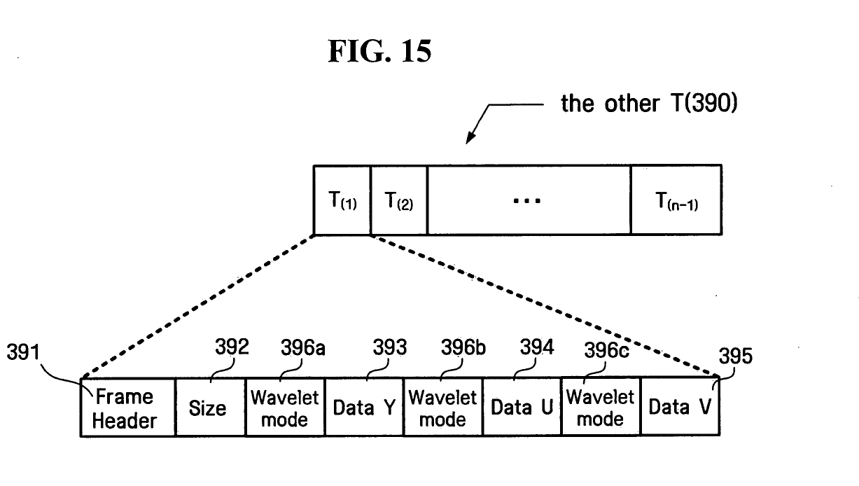

In this case, a bitstream 300 may have the same structure as shown in FIG. 11, 13, or 15. As shown in FIG. 15, wavelet mode fields 396a, 396b, and 396c may be additionally placed in front of each of Y, U, and V data. Alternatively, rather than additionally placing in front of each of the Y, U, and V data, the wavelet mode fields 396a, 396b, and 396c may be collectively placed at a portion of the frame header 391.

In another exemplary embodiment, one frame is divided into a plurality of partitions and an appropriate mode may be selected for each partition. This is because smooth image portions and sharp image portions coexist within one frame.

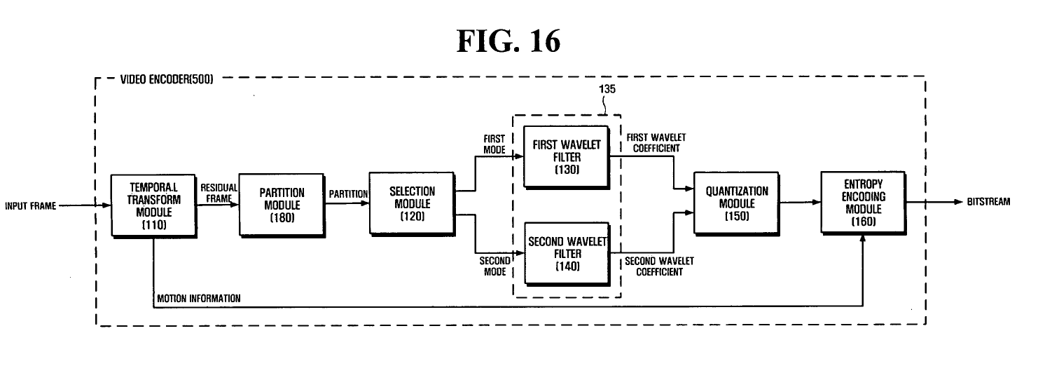

FIG. 16 shows a video encoder 500 in such a case. The video encoder 500 shown in FIG. 16 is different from the video encoder shown in FIG. 4, in that a partition module 180 is further provided before the selection module 120 and every operation is performed by partition after passing through the partition module 180.

The video encoder 500 includes a temporal transform module 110, the partition module 180, selection module 120, a wavelet transform module 135, and a quantization module 150. The temporal transform module 110 removes temporal redundancy of an input frame and generates a residual frame. The partition module 180 divides the residual frame into partitions having a predetermined size. The selection module 120 selects an appropriate wavelet filter among a plurality of wavelet filters having different taps according to a spatial correlation of divided partitions. The wavelet transform module 135 performs a waveform transform on the partitions using the selected wavelet filter to generate wavelet coefficients. The quantization module 150 quantizes the wavelet coefficients.

The partition module 180 divides the residual frame supplied from the temporal transform module 110 into partitions having a predetermined size. The partitions are obtained by dividing the residual frame at equal intervals in horizontal and vertical directions, that is, M×N blocks. Any division method can be used. However, dividing the partitions into too small blocks may deteriorate the performance due to a waveform transform. Thus, it is preferable to divide the frame into blocks substantially larger than macroblocks.

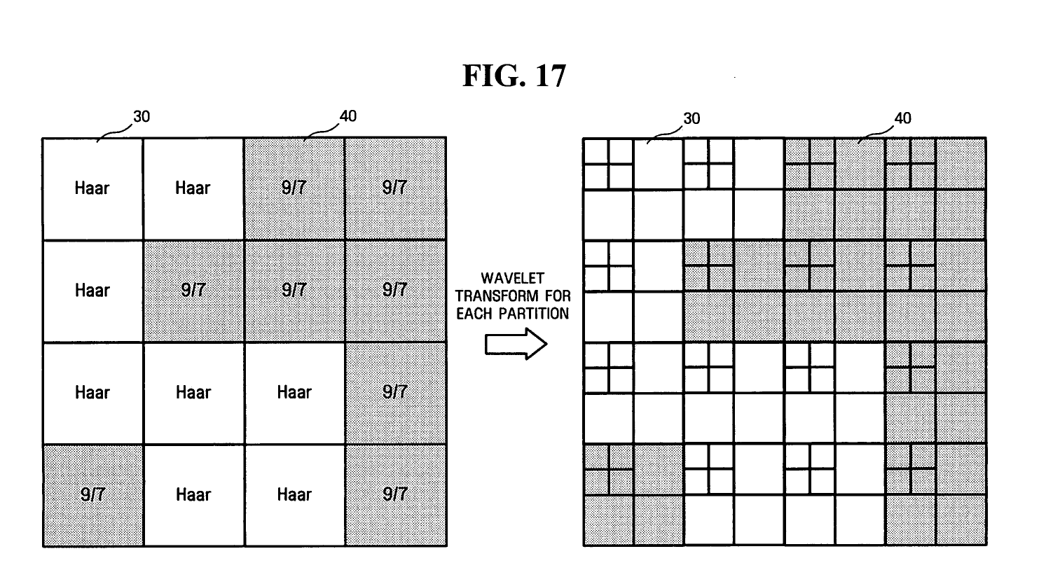

FIG. 17 illustrates a decomposition example of an input residual frame into 4×4 blocks. In this case, the selection module 120 selects an appropriate mode of a first mode and a second mode for each partition. The wavelet transform module 135 performs a waveform transform for each partition according to the selected mode using the first wavelet filter 130 or the second wavelet filter 140. Mode selection by partition is determined whether the histogram of pixel values of partitions are well compliant with the Gaussian distribution, as shown in FIG. 4.

In a case where a Haar filter is used as the first wavelet filter 130 and a 9/7 wavelet filter is used as the second wavelet filter 140, as shown in FIG. 17, the selection module 120 selects a first mode, i.e., a Haar filter mode, for partitions 30, so that the partitions 30 are subjected to a waveform transform using the Haar filter. The selection module 120 selects a second mode, i.e., a 9/7 filter mode, for partitions 40, so that the partitions 40 are subjected to a waveform transform using the 9/7 filter.

The quantization module 160 quantizes the wavelet transformed partitions, respectively.

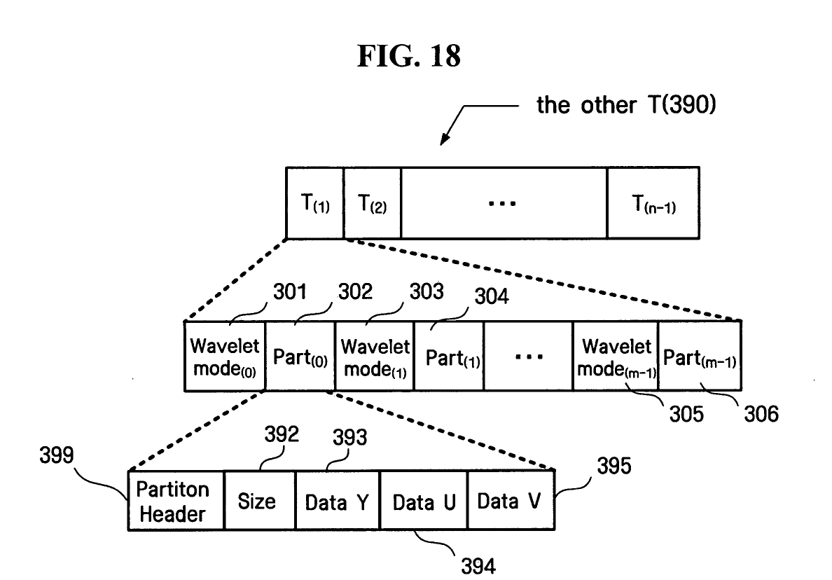

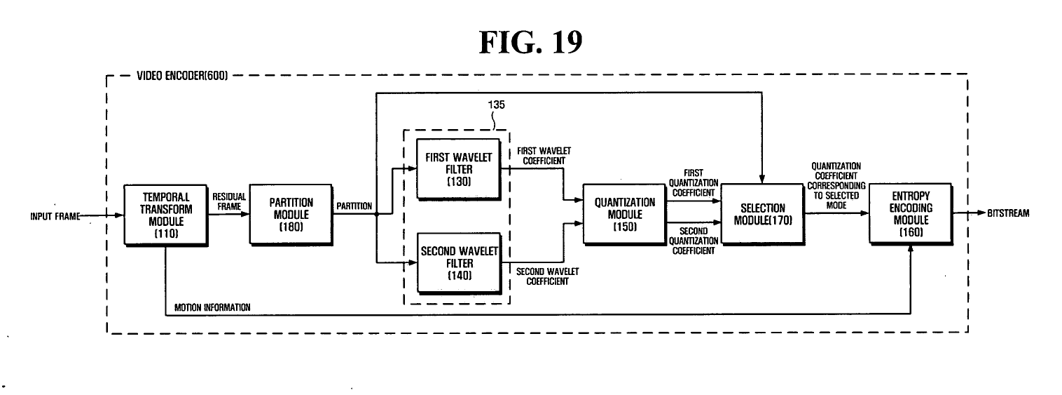

In a case where a wavelet filter mode is selected by partition, the bitstream 300 may have such structures as shown in FIG. 11 through 13, and 18. As shown in FIG. 18, texture data T₍₁₎ through T₍ₙ₋₁₎) may include Part fields 302, 304, and 306, in which multiple (m) partition data are recorded, and wavelet mode fields 301, 303, and 305, which are positioned in front of each part field to indicate in which mode each field is to be wavelet transformed. This enables a video encoder to inform a video decoder in which mode each partition has been wavelet-transformed.

FIG. 19 shows a modified exemplary embodiment of the exemplary embodiment shown in FIG. 9, which is employed a wavelet transform mode determined by partition is shown. A video encoder 600 may include a temporal transform module 110, a partition module 180, a wavelet transform module 135, a quantization module 150, a selection module 170, and an entropy encoding module 160.

The temporal transform module 110 removes temporal redundancy of an input frame and generates a residual frame. The partition module 180 divides the residual frame supplied from the temporal transform module 110 into partitions having a predetermined size. The wavelet transform module 135 performs a wavelet transform on the partitions using the plurality of wavelet filters and generates plural sets of wavelet coefficients, that is, first wavelet coefficients and second wavelet coefficients, for the partitions. The quantization module 150 quantizes the plural sets of wavelet coefficients. The selection module 170 reconstructs a plurality of residual partitions from the plural sets of quantized coefficients, compares quality differences of the plurality of residual partitions with each other, and selects a wavelet filter for a frame having a better quality. Here, the reconstructed residual partitions are created through a reconstruction process of a quantized coefficient for a partition, that is, an inverse quantization and an inverse wavelet transform. As shown in FIG. 19, when the number of wavelet filters are two, the plurality of residual partitions correspond to a first residual partition and a second residual partition.

The selection module 170 includes an inverse quantization module 171, an inverse wavelet transform module 176, and a picture quality comparison module 174. The inverse quantization module 171 performs inverse quantization on the plural sets of quantized coefficients. The inverse wavelet transform module 176 performs an inverse wavelet transform on the inverse quantized coefficients using the corresponding plurality of inverse wavelet filters to reconstruct a plurality of residual partitions. The picture quality comparison module 174 compares picture qualities of the reconstructed plurality of residual partitions with each other and selects a wavelet filter for a partition having a better quality.

Processes after partitioning by the partition module 180 are substantially the same as those in FIGS. 9 and 10 except that every operation is performed by partition. Since one skilled in the art can readily practice without additional explanation, repeated explanation will not be given.

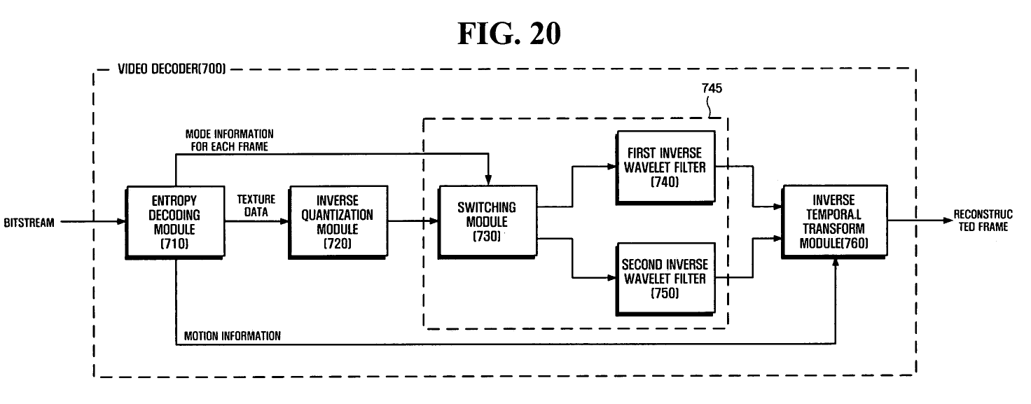

FIG. 20 is a schematic diagram of a video decoder 700 according to an exemplary embodiment of the present invention, which includes an entropy decoding module 710, inverse quantization module 720, an inverse wavelet transform module 745, and an inverse temporal transform module 760.

The entropy decoding module 710 operates in a reverse manner to entropy coding performed in an encoder. The entropy decoding module 710 interprets an input bitstream and extracts motion information, texture data, and mode information. The mode information may be mode information by frame, or mode information by color components, that is, by Y, U, and V components.

The inverse quantization module 720 inversely quantizes texture data transferred from the entropy decoding module 710. The inverse quantization is a process of reconstructing values matched with indices generated during quantization using a quantization table used during quantization. The quantization table may be transferred from the encoder end or prescribed between the encoder and the decoder.

The inverse wavelet transform module 745 performs an inverse wavelet transform on the texture data using one inverse wavelet filter among a plurality of inverse wavelet filters, the one inverse wavelet filter corresponding to mode information containing the bitstream.

The switching module 730 supplies the inversely quantized result according to the mode information to the first inverse wavelet filter 740 or the second inverse wavelet filter 750.

In a case where the mode information is a first mode, the first inverse wavelet filter 740 performs an inverse filtering process on the inverse quantized result to correspond to the filtering process performed by the first wavelet filter 130 having a relatively shorter tap.

In a case where the mode information is a second mode, the second inverse wavelet filter 750 performs an inverse filtering process on the inverse quantized result to correspond to the filtering process performed by the second wavelet filter 140 having a relatively longer tap.

The inverse temporal transform module 760 reconstructs a video frame from the frame transferred from the first inverse wavelet filter 740 or the second inverse wavelet filter 750 according to the mode information. In this case, the inverse temporal transform module 760 performs a motion compensation using the motion information transferred from the entropy decoding module 710 to form a temporal prediction frame, and adds the transferred frame and the prediction frame, thereby reconstructing a video sequence.

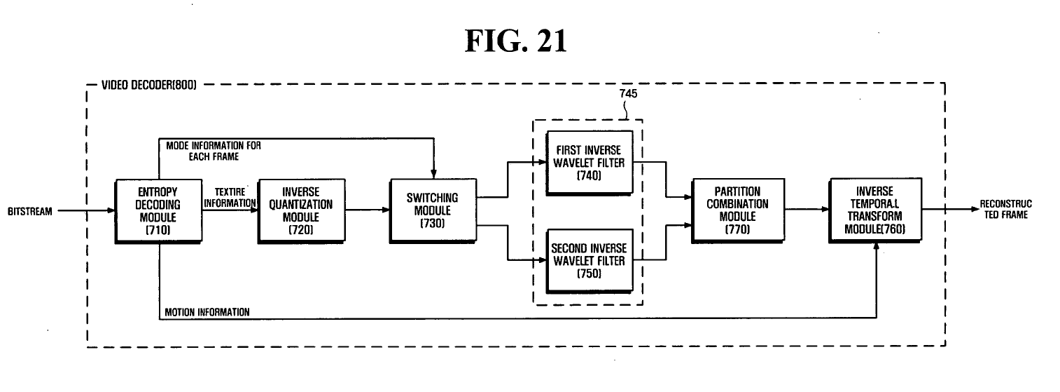

FIG. 21 is a schematic diagram of a video decoder 800 according to an exemplary embodiment of the present invention, in which the configuration of the video decoder 800 corresponds to that of each of the video encoders shown in FIGS. 16 and 19, which select a wavelet filter mode by partition.

The video decoder 800 operates in an order reverse to the entropy coding order at the encoder end. The video decoder 800 may include an entropy decoding module 710, an inverse-quantization module 720, an inverse wavelet module 745, a partition combination module 745, and an inverse-temporal transformation module 760. The entropy decoding module 710 interprets an input bit-stream to extract information regarding motion, texture data, mode, and so on, by partition. The inverse-quantization module 720 inversely quantizes the information regarding the texture data. The partition combination module 745 performs an inverse wavelet transform on texture data by partition using an inverse wavelet filter corresponding to mode information by partition contained in the bitstream among a plurality of inverse wavelet filters. The partition combination module 770 combines the wavelet-transformed partitions and reconstructs a single residual image. The inverse temporal transform module 760 reconstructs a video sequence using the residual image and motion information contained in the bitstream.

The exemplary embodiment shown in FIG. 21 is different from the exemplary embodiment shown in FIG. 20 in that an inverse wavelet transform method is selected by partition. Thus, a video decoder 800 further includes a partition combination module 770, and operations are performed in units of partitions before the partition combination module 770 reconstructs a residual frame from the plurality of partitions which have been inversely quantized. The mode information for each partition provided from the entropy decoding module 710 makes it possible to be informed in which mode each partition is to be inversely wavelet transformed.

In the above-described exemplary embodiments, the present invention has been described using a video encoder and a video decoder in which an input still image is encoded and decoded. The present invention is not restricted thereto. For example, the above-described exemplary embodiments, excluding a temporal processing such as temporal conversion or inverse temporal conversion, can be readily envisioned by a person of ordinary skill in the art.

In addition, in the above-described exemplary embodiments the present invention, while it has been described that one of two wavelet filters is selected and used, the invention is not restricted thereto. A person of ordinary skill in the art can sufficiently practice the present invention with reference to the above-described exemplary embodiments by selecting an appropriate number of wavelet filters among three or more wavelet filters.

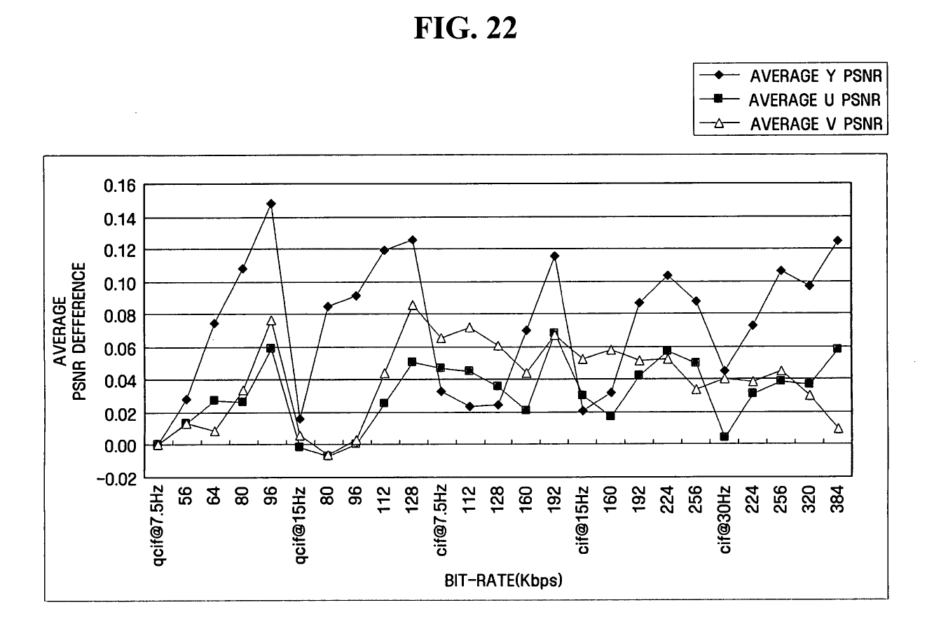

FIG. 22 is a graph showing a PSNR difference depending on Y-U-V component when mobile sequences are encoded with adaptive spatial transformation and without adaptive spatial transformation, in which the abscissa indicates multiple resolution levels, frame rates, or bit rates, and the ordinate indicates PSNR differences with and without adaptive spatial transformation (Haar filter and 9/7 filter). As shown in FIG. 22, the effect of adaptive spatial transformation is very excellent. That is, the PSNR difference is over 0.15 dB in mobile sequences.

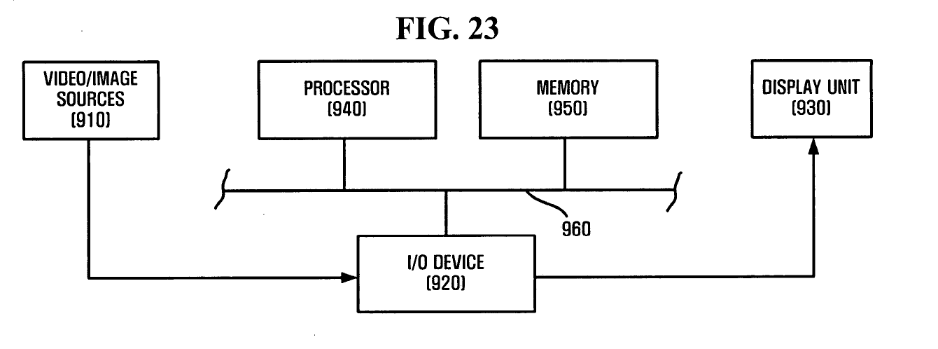

FIG. 23 is a block diagram of a system for performing an encoding, or decoding method according to an exemplary embodiment of the present invention. The system may represent a television, a set-top box, a desktop, laptop or palmtop computer, a personal digital assistant (PDA), a video/image storage device such as a video cassette recorder (VCR), a digital video recorder (DVR), a TiVO device, etc., as well as portions or combinations of these and other devices. The system includes one or more video/image sources 910, one or more input/output devices 920, a processor 940 and a memory 950. The video/image source(s) 910 may represent, e.g., a television receiver, a VCR or other video/image storage device. The source(s) 910 may alternatively represent one or more network connections for receiving video from a server or servers over, e.g., a global computer communications network such as the Internet, a wide area network, a metropolitan area network, a local area network, a terrestrial broadcast system, a cable network, a satellite network, a wireless network, or a telephone network, as well as portions or combinations of these and other types of networks.

The video/image source 910 may be a TV receiver, a VCR, or other video/image storing apparatus. The video/image source 910 may indicate at least one network connection for receiving a video or an image from a server using Internet, a wide area network (WAN), a local area network (LAN), a terrestrial broadcast system, a cable network, a satellite communication network, a wireless network, a telephone network, or the like. In addition, the video/image source 910 may be a combination of the networks or one network including a part of another network among the networks.

The input/output unit 920, the processor 940, and the memory 950 communicate with one another through a communication medium 960. The communication medium 960 may be a communication bus, a communication network, or at least one internal connection circuit. Input video/image data received from the video/image source 910 can be processed by the processor 940 using at least one software program stored in the memory 950 and can be executed by the processor 940 to generate an output video/image provided to the display unit 930.

In particular, the software stored in the memory 950 may include a scalable wavelet based codec implementing the method according to the present invention. The codec may be stored in the memory 950, may be read from a storage medium such as a compact disc-read only memory (CD-ROM) or a floppy disc, or may be downloaded from a predetermined server through a variety of networks.

According to the present invention, wavelet transformation can be adaptively performed according to characteristics of input frames.

In addition, the adaptive wavelet transformation according to the present invention can be applied in various manners: by frame, color component, or partition.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described exemplary embodiments have been provided only in a descriptive sense and will not be construed as placing any limitation on the scope of the invention.

What is claimed is:

1. A video encoder comprising:
a temporal transform module that generates a residual frame by removing temporal redundancy of an input frame;
a selection module that selects a wavelet filter among a plurality of wavelet filters having different taps according to a spatial correlation of the residual frame;
a wavelet transform module that generates wavelet coefficients by performing a waveform transform on the residual frame using the selected wavelet filter; and
a quantization module that quantizes the wavelet coefficients.

2. The video encoder of claim 1, further comprising a bitstream generation module that losslessly encodes a quantized result output by the quantization module.

3. The video encoder of claim 1, wherein if the spatial correlation is high, the selected wavelet filter is a wavelet filter having a relatively longer tap, and if the spatial correlation is low, the selected wavelet filter is a wavelet filter having a relatively shorter tap, among the plurality of wavelet filters.

4. The video encoder of claim 1, wherein the spatial correlation is determined based on whether a histogram of pixel values of the residual frames are compliant with Gaussian distribution.

5. The video encoder of claim 1, wherein the wavelet filters comprise a Haar filter and a 9/7 wavelet filter.

6. The video encoder of claim 1, wherein the residual frame is decomposed by color components.

7. An image encoder comprising:
a selection module that selects a wavelet filter among a plurality of wavelet filters having different taps according to a spatial correlation of input images;
a wavelet transform module that generates wavelet coefficients by performing a wavelet transform using the selected wavelet filter; and
a quantization module that quantizes the wavelet coefficient.

8. A video encoder comprising:
a temporal transform module that generates a residual frame by removing temporal redundancy of an input frame;
a wavelet transform module that generates a plurality of sets of wavelet coefficients by performing wavelet transforms on the residual frame using a plurality of wavelet filters;
a quantization module that generates a plurality of sets of quantized coefficients by quantizing the plurality of sets of wavelet coefficients; and
a selection module that reconstructs a plurality of residual frames from the plurality of sets of quantized coefficients, compares quality differences of the plurality of residual frames with each other and selects a wavelet filter for a frame having a better quality.

9. The video encoder of claim 8, wherein the selection module comprises:
an inverse quantization module that inverse quantizing the plurality of sets of quantized coefficients;
an inverse wavelet transform module that reconstructs a plurality of residual frames by transforming the inversely quantized coefficients using a corresponding inverse wavelet filter; and
a picture quality comparison module compares qualities of the reconstructed residual frames with each other and selects a wavelet filter for a frame having a better quality.

10. The video encoder of claim 9, wherein the frame having a better quality is a frame having a smaller sum of differences from residual frames generated by the temporal transform module among the plurality of residual frames.

11. The video encoder of claim 8, wherein the residual frames are decomposed by color components.

12. A video encoder comprising:
a temporal transform module that generates a residual frame by removing temporal redundancy of an input frame;
a partition module that divides the residual frame into partitions having a predetermined size;
a selection module that selects a wavelet filter among a plurality of wavelet filters having different taps according to a spatial correlation of the partitions;
a wavelet transform module that generates wavelet coefficients by performing a waveform transform on the residual frame using the selected wavelet filter; and
a quantization module that quantizes the wavelet coefficients.

13. The video encoder of claim 12, wherein the spatial correlation is determined based on whether a histogram of pixel values of the residual frames are compliant with Gaussian distribution.

14. A video encoder comprising:
a temporal transform module that generates a residual frame by removing temporal redundancy of an input frame;
a partition module that divides the residual frame into partitions having a predetermined size;
a wavelet transform module that generates a plurality of sets of wavelet coefficients by performing a wavelet transform on the partitions using a plurality of wavelet filters;
a quantization module that generates a plurality of sets of quantized coefficients by quantizing the plurality of sets of wavelet coefficients; and
a selection module that reconstructs a plurality of residual partitions from the plurality of sets of quantized coefficients, compares quality differences of the plurality of residual partitions with each other and selects a wavelet filter for a frame having a better quality.

15. The video encoder of claim 14, wherein the selection module comprises:
an inverse quantization module that inverse quantizing the plurality of sets of quantized coefficients;
an inverse wavelet transform module that transforms the inversely quantized coefficients using the corresponding inverse wavelet filter to reconstruct a plurality of residual frames; and
a picture quality comparison module compares qualities of the reconstructed residual frames with each other and select the wavelet filter for a the having the better quality.

16. A video decoder comprising:
an inverse quantization module that inversely quantizes texture data contained in an input bitstream;
an inverse wavelet module that performs an inverse wavelet transform on the texture data using an inverse wavelet filter among a plurality of inverse wavelet filters, the inverse wavelet filter corresponding to mode information included in the bitstream; and
an inverse temporal transform module that performs an inverse temporal transform and reconstructs a video sequence using an inverse wavelet transform result and motion information included in the bitstream.

17. The video decoder of claim 16, wherein the plurality of inverse wavelet filters comprise a Haar filter and a 9/7 wavelet filter.

18. The video decoder of claim 16, wherein the text data are frames decomposed by color components.

19. A video decoder comprising:
an inverse quantization module that inversely quantizes texture data contained in an input bitstream;
an inverse wavelet module that performs an inverse wavelet transform on the texture data for each partition using an inverse wavelet filter among a plurality of inverse wavelet filters, the inverse wavelet filter corresponding to mode information included in the bitstream;
a partition combination module that reconstructs a residual image by combining the wavelet-transformed partitions; and
an inverse temporal transform module that reconstructs a video sequence using the residual image and motion information included in the bitstream.

20. A video encoding method comprising:
removing temporal redundancy of an input frame to generate a residual frame;
selecting a wavelet filter among a plurality of wavelet filters having different taps according to a spatial correlation of the residual frame;
performing a waveform transform on the residual frame using the selected wavelet filter to generate wavelet coefficients; and
quantizing the wavelet coefficients.

21. A video encoding method comprising:
removing temporal redundancy of an input frame to generate a residual frame;
performing wavelet transforms on the residual frame using a plurality of wavelet filters to generate a plurality of sets of wavelet coefficients;
quantizing the plurality of sets of wavelet coefficients to generate a plurality of sets of quantized coefficients; and
reconstructing a plurality of residual frames from the plurality of sets of quantized coefficients, comparing quality differences of the plurality of residual frames with each other and selecting a wavelet filter for a frame having a better quality.

22. The video encoding method of claim 21, wherein the selecting comprises:
inversely quantizing the plurality of sets of quantized coefficients;
transforming the inversely quantized coefficients using a corresponding inverse wavelet filter and reconstructing a plurality of residual frames; and
comparing qualities of the reconstructed residual frames with each other and selecting wavelet filter for a frame having a better quality.

23. A video encoding method comprising:
removing temporal redundancy of an input frame to generate a residual frame;
dividing the residual frame into partitions having a predetermined size;
selecting a wavelet filter among a plurality of wavelet filters having different taps according to a spatial correlation of the partitions;
performing a waveform transform on the residual frame using the selected wavelet filter to generate wavelet coefficients; and
quantizing the wavelet coefficients.

24. A video encoding method comprising:
removing temporal redundancy of an input frame to generate a residual frame;
dividing the residual frame into partitions having a predetermined size;
selecting a wavelet filter among a plurality of wavelet filters having different taps according to a spatial correlation of the partitions;
performing a waveform transform on the residual frame using the selected wavelet filter to generate wavelet coefficients; and
quantizing the wavelet coefficients.

25. A video decoding method comprising:
inversely quantizing texture data contained in an input bitstream;
performing an inverse wavelet transform on the texture data using an inverse wavelet filter among a plurality of inverse wavelet filters, the inverse wavelet filter corresponding to mode information included in the bitstream; and
performing an inverse temporal transform and reconstructing a video sequence using an inverse wavelet transform result and motion information included in the bitstream.

26. A video decoding method comprising:
inversely quantizing texture data contained in an input bitstream;
performing an inverse wavelet transform on the texture data for each partition using an inverse wavelet filter among a plurality of inverse wavelet filters, the inverse wavelet filter corresponding to mode information included in the bitstream;
combining the wavelet-transformed partitions and reconstructing a residual image; and
reconstructing a video sequence using the residual image and motion information included in the bitstream.
